(19) United States
(12) Patent Application Publication
(10) Pub. No.: US 2012/0203744 A1
(43) Pub. Date: Aug. 9, 2012

(54) MAINTAINING DATA INTEGRITY ACROSS EXECUTION ENVIRONMENTS

(76) Inventors: Shane Andrew Mercer, Wellington (NZ); Lindsay Ian Smith, Wellington (NZ); John Mathew Martin, Wellington (NZ)

(21) Appl. No.: 13/501,784

(22) PCT Filed: Oct. 8, 2010
(86) PCT No.: PCT/NZ2010/000200

§ 371 Date: Apr. 13, 2012

Related U.S. Application Data
(60) Provisional application No. 61/252,162, filed on Oct. 16, 2009.

(51) Int. Cl. G06F 17/30; G06F 7/00

(52) U.S. Cl. 707/687; 707/E17.005; 707/E17.044

(57) ABSTRACT

Current computing solutions often involve the sharing of data across multiple computer implemented processes. To ensure data integrity throughout the execution environment, an executing process can make a request for data from a Data Provider. In response to the request, the Data Provider can bundle the data and one or more Validation Objects in a Data Object. The Data Object can be passed between executing processes, and at any point in the execution, an executing process can verify the integrity of the data by making a request to the Data Object. To facilitate the passing of Data Objects throughout a heterogeneous execution environment, a Data Object can create a representation of itself specific to the target system. The Data Objects are advantageous in that all of the necessary validation checks are centralized, thus decreasing maintenance costs and the possibility of error.

### CROSS REFERENCE TO RELATED APPLICATIONS

This application claims the benefit of U.S. Provisional Patent Application No. 61/252,162 entitled “MAINTAINING DATA INTEGRITY ACROSS EXECUTION ENVIRONMENTS” filed on Oct. 16, 2009, and which is hereby expressly incorporated herein by reference in its entirety.

### BACKGROUND

1. Technical Field

The present disclosure relates to verifying data in a computer implemented process and more specifically to verifying data in a computer implemented process where the data can be transferred throughout a heterogeneous execution environment.

2. Introduction

Current computing solutions often include a variety of modules working together to provide the desired functionality. The modules can all reside on a single computing device; however, it is becoming increasing common for the modules to be distributed across multiple computing devices. Furthermore, the distributed computing solution may be composed of a variety of different device types and architectures. Despite the heterogeneous nature of the computing solution, the different modules may frequently be required to share data. As the data moves between the various modules and environments it may be necessary to verify that the data is in an accurate or valid representation. To accomplish this, validation rules may be defined that govern the data. To execute the validation rules, validation methods specific to the execution environment can be included with each module. Each time the rules governing the data change, the validation method associated with each module must also be changed. This can result in significant maintenance overhead as well as the potential for error if the required rule change is not propagated to all of the verification methods.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed herein are systems, methods, and non-transitory computer-readable storage media for maintaining data integrity across a heterogeneous execution environment. Current computing solutions often involve the sharing of data across multiple computer implemented processes. As the data moves between computer implemented processes, and possibly various storage locations, it may be necessary to verify that the data is in an accurate or valid representation. To address the limitations associated with adding and maintaining multiple validation checks, the data and validation rules can be encapsulated in a Data Object, which can be passed between the various computer implemented processes.

A Data Object can be composed of data and one or more Validation Objects. A Validation Object can specify a single “validate” function that performs the actions to carry out one or more validation rules associated with the data. The computer implemented process executes a request for data from outside the process and a transmission of data out of the process with the use of a Data Object rather than bare data.

To facilitate the creation of Data Objects, one or more Data Providers can reside in the execution environment. A Data Provider can be a channel through which data enters and exits an executing computer implemented process. A Data Provider can specify two functions: “retrieveDataObject” and “storeDataObject.” Upon a request to retrieve data, a Data Provider obtains the requested data and one or more Validation Objects. The Validation Objects can be created based on the validation rules maintained in the Data Provider. Upon a request to store a Data Object, the Data Provider can update the data storage location and/or the validation rules.

At any point during execution, a request to validate the data contained in a Data Object can be made. The validation request can be made directly to the Data Object. Upon receiving the validation request, the Data Object can instruct each of the Validation Objects to test the validity of the data. The Data Object can collect the results of the validation checks and return them to the requesting computer implemented process.

To address the heterogeneous nature of many execution environments, a Data Object can include export functionality in which the Data Object can create a representation of itself appropriate for a target computer implemented process. Upon receiving the export request, the Data Object instructs each of the Validation Objects to create an appropriate Validation Object representation of itself The new Validation Objects are then encapsulated with the data to create the exportable Data Object for the target computer implemented process. When the exported Data Object reaches the target computer implemented process, the process is capable of accessing the data and verifying the data based on the same rules that were defined for the source process.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an exemplary execution environment;

FIG. 2 illustrates an exemplary Data Object;

FIG. 3 illustrates an exemplary data retrieval method;

FIG. 4 illustrates an exemplary data storage method;

FIG. 5 illustrates an exemplary data validation method;

FIG. 6 illustrates an exemplary data exportation method;

FIG. 7 illustrates an exemplary method embodiment for maintaining data integrity across execution environments; and

FIG. 8 illustrates an exemplary system embodiment.

### DETAILED DESCRIPTION

Various embodiments of the disclosure are discussed in detail below. While specific implementations are discussed, it should be understood that these implementations are for illustration purposes only. A person skilled in the relevant art will recognize that other components and configurations may be used without parting from the spirit and scope of the disclosure.

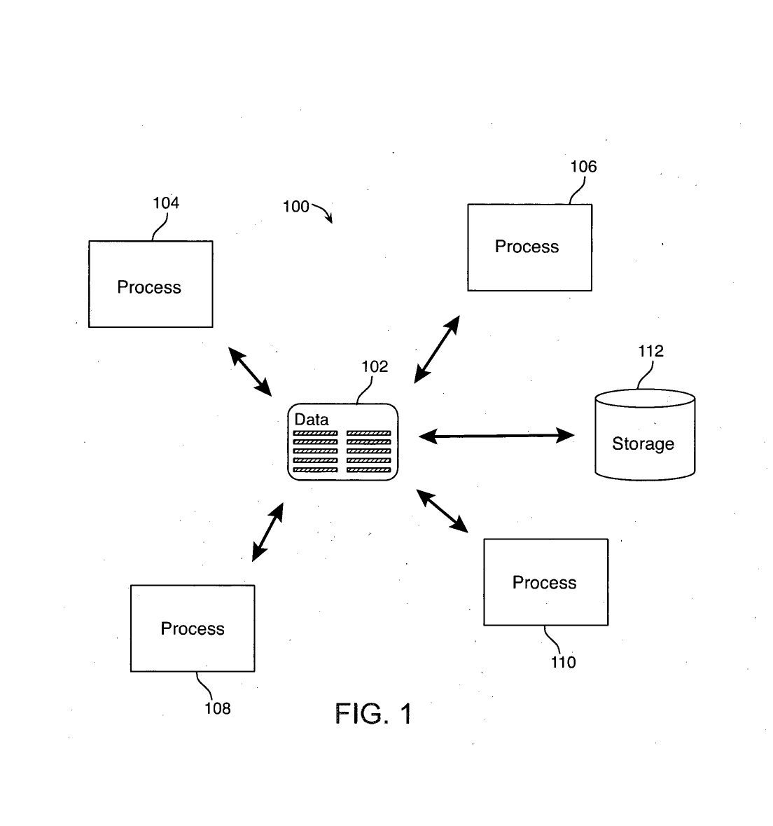

The present disclosure addresses the need in the art for a method of verifying data integrity as the data moves between different computing environments. An exemplary execution environment 100 is illustrated in FIG. 1 wherein a number of computer implemented processes 104, 106, 108, and 110 and a storage device 112 all utilize data 102. In FIG. 1, each of the computer implemented processes 104, 106, 108, and 110 can read and/or edit data 102, send data 102 to or receive data 102 from another computer implemented process, and/or request data 102 from or save data 102 to storage device 112.

In some configurations, the computer implemented processes 104, 106, 108, and 110 can be executing on a single computing device. However, the computer implemented processes can also be executing on one or more computing devices that communicate via a network. Furthermore, the one or more computing devices can be of varying types such as servers; desktop computers; mobile computers; handheld communications devices, e.g. mobile phones, smart phones, tablets; and/or any other computing devices. Additionally, the storage device can reside on the same computing device as one or more of the computer implemented processes or the storage device can reside on a separate computing device, such as a server or external hard drive.

The execution environment 100 can be configured for use on a local area network or any other network configuration that facilitates the intercommunication of electronic devices. For example, each of the components in the execution environment 100 can be implemented in a localized or distributed fashion in a network. It should be clear to one of skill in the art that the execution environment 100 can include any number of computer implemented processes, storage devices, and/or pieces of data and that not all computer implemented processes and/or storage devices may utilize a particular item of data.

The execution environment 100 illustrated in FIG. 1 can be a common configuration in current computing solutions. That is, it can be common for one or more computer implemented processes executing on one or more computing devices to all utilize the same data. For example, one computer implemented process may be used to gather the data from the user, while a second computer implemented process may use the data in a task. Furthermore, the first computer implemented process may gather the data and store it to a database or file. The second computer implemented process may fetch the data from the database or file prior to using it. At each stage of the gather, store, fetch, use process there is the possibility that the data can end up with an improper representation. The improper representation can result from a number of factors, such as the data entered by the user did not conform to the requirements or the data was corrupted.

A solution that is currently used to ensure that the data is in an accurate or valid representation is to define validation rules that govern the data. Based on the validation rules, a validation check can be implemented and added to the computer implemented process responsible for gathering the data. Unfortunately, unless validation checks are added at various points in the system, the system may still attempt to utilize the data in an improper form. Therefore, a validation check should also be added to any computer implemented process that in some way utilizes the data. Based on this solution, a validation check would need to be added to computer implemented processes 104, 106, 108, and 110 and, depending on the type of storage device, possibly storage device 112, also.

With this solution, each time the validation rule governing the data is changed, each computer implemented process that includes the validation check must also be updated. The updating process can be time-consuming and error prone. Additionally, the maintenance overhead can be further complicated in a heterogeneous execution environment where a variety of validation check implementations must be maintained.

To illustrate a possible use of execution environment 100 based on the validation solution described above, suppose data 102 are customer records that are transferred from one execution environment to another. The customer record may contain a field for the customer's email address. To ensure that the email address provided is accurate, a validation rule can be defined that requires the data to contain one “@” symbol. The customer data may be retrieved from a server executing a web application. A check for the valid email field can be implemented in code running in that server's execution environment. As part of the web application, the server may send to the user's browser HTML and JavaScript code that implements the web page that is displayed to the user. For the user to be able to view and manipulate the customer data, it is sent to the execution environment of the web browser. A second validation check is added in the browser execution environment to enforce the email field rule.

The validation solution described above can be improved by encapsulating the validation rules and the data in a single Data Object. Through the encapsulation, all of the validation checks can be contained in a single location. Therefore, any time a validation rule is changed, all of the checks can easily be identified and updated. This can decrease the amount of maintenance required and reduce the risk of error associated with a failure to update one or more validation checks.

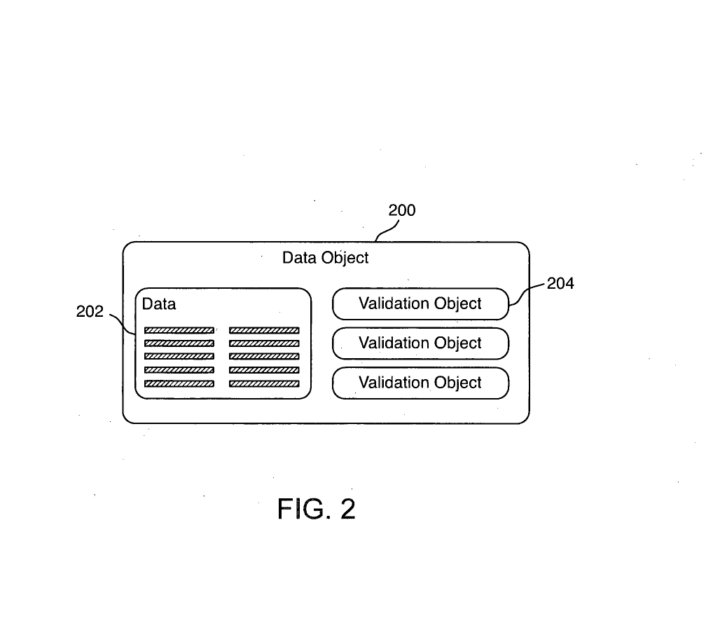

FIG. 2 illustrates an exemplary Data Object 200. A Data Object 200 can be made up of data 202 and one or more Validation Objects 204. The type of data contained in a Data Object 200 can vary with the configuration of the execution environment. In some cases, the data can be raw data and the executing computer implemented process using the data can be responsible for analyzing it and extracting the information needed by that computer implemented process. In other cases, the data can be in a particular format. In some cases, the size of the data contained in the Data Object can be quite large. In other cases, the size of the data can be small. For example, the data in a Data Object may be all of the customer records, customer records for a specific period of time, the records associated with a single customer, a single field in the customer records, etc.

A Validation Object can specify a single “validate” function that performs the actions to carry out one or more validation rules. The “validate” function can be configured such that the Validation Object only validates a single aspect of the data, such as an email field within a customer record. Alternatively, the “validate” function can be configured to validate multiple aspects of the data or the entire data. For example, a Validation Object may be configured to ensure that the total number of fields in the data does not exceed some predefined value. The Validation Object can be implemented using any programming language, e.g. Java, C++, etc. For example, the code below illustrates a possible interface for implementing a Validation Object.

public interface ValidationObject {

public void validate(DataObject dataObject);

}

In this example, to implement the Validation Object, the user can simply implement the “validate” function, which takes a single Data Object as a parameter. Other methods of implementing a Validation Object are also possible. For example, additional parameters are possible and/or instead of passing a Data Object, the actual data can be passed as a parameter. Additionally, a user is not limited to using a single programming language to implement all of the Validation Objects associated with a single data set; multiple programming languages can be used to implement the Validation Objects.

Like the Validation Objects, a Data Object can be implemented using any programming language, e.g. Java, C++, etc. For example, the code below illustrates the basics of a possible class for implementing a Data Object.

public class DataObject {

private List _data = new List( );
private List _validators = new List( );
public addData(Data data){

_data.add(data);

}
public List getData( ) {

return _data;

}
public replaceData(Data oldData, Data newData){

_data.replace(oldData, newData);

}
}

The Data Object can include Lists to maintain the data and the Validation Objects. Other data structures or storage types can also be used to maintain the data in the Data Object. Furthermore, the Data Object can include functionality to manipulate the data as well as other types of functionality as needed.

With the Data Object solution, when a computer implemented process requests a set of data, instead of receiving the bare data, the computer implemented process can receive a Data Object. To facilitate this request, the execution environment 100 can include one or more Data Providers. A Data Provider can reside in a number of places in the execution environment 100. For example, a Data Provider can be a stand-alone computer implemented process. A Data Provider can also be part of a computer implemented process that includes other functionality in addition to the Data Provider. Furthermore, a Data Provider can reside on the same computing device as the computer implemented process requesting the Data Object. However, the Data Provider can receive requests from computer implemented processes executing on other computing devices. A Data Provider can also receive requests from one or more different computing implemented processes. For example, the execution environment 100 can be configured such that the execution environment 100 contains a single Data Provider that resides on the server hosting the data storage 112. To retrieve the data 102 from the data storage 112, each of the executing computer implemented process 104, 106, 108, and 110 can make a request to the Data Provider. Other configurations are also possible.

A Data Provider can be a channel through which data enters and exits an executing computer implemented process. As illustrated in the pseudo code below, a Data Provider can specify two functions: a “retrieveDataObject” function and a “storeDataObject” function. However, other methods of making a retrieve and/or store request are also possible.

public interface DataProvider {

DataObject retrieveDataObject(String operationName, Map
parameters);
void storeDataObject(DataObject object);
}

In the above exemplary Data Provider pseudo code, an executing computer implemented process can facilitate the retrieval method by supplying two parameters: “operationName” and “parameters.” The “operationName” parameter can be used to indicate what type of data is being requested. For example, if the data set consists of customer records, the requesting computer implemented process may be interested in receiving all of the customer records or just a subset of the records. The “parameters” parameter can contain additional information that helps facilitate the identification of the requested data. For example, if the request is for a subset of the customer records, the “parameters” parameter may specify a set of customer IDs for the desired customer records. In some configurations, different parameters can be supplied to the retrieve function.

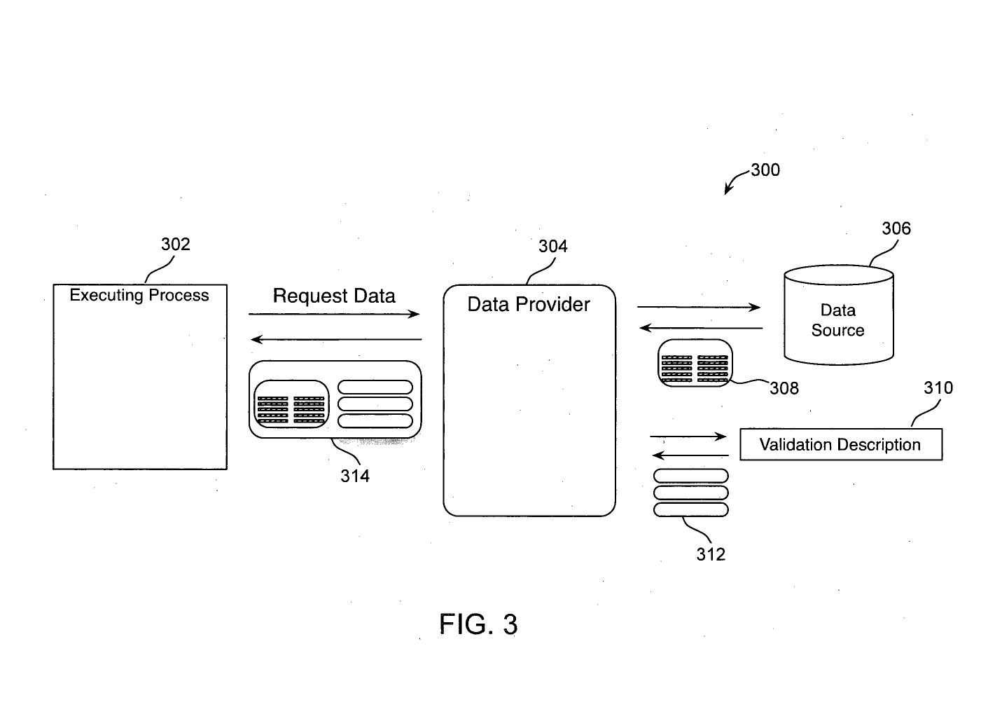

The retrieve Data Object functionality is illustrated in the exemplary method 300 in FIG. 3. The executing computer implemented process 302 can make a retrieve request to the Data Provider 304. Upon receiving the request, the Data Provider 304 obtains the requested data 308. The requested data 308 can be obtained in a number of ways depending on the configuration of the execution environment. In some cases, the Data Provider 304 can retrieve the data from a database, such as Data Source 306. In this case, the Data Provider 304 can include functionality for communicating with the database and for transforming the results into a data format suitable for the requesting computer implemented process 302. The Data Provider 304 can also be configured to retrieve the data from a file stored on a computing device. In this case, the Data Provider 304 can include functionality for identifying where the file is located, retrieving the file, and transforming the results into a data format suitable for the requesting computer implanted process 302. Alternatively, the Data Provider 304 can be configured to create the data internally and/or derive the data from some other source, such as a database or file.

In addition, to obtaining the data 308, the Data Provider 304, can obtain one or more Validations Objects 312. The Validation Objects 312 can be based on the validation description 310 associated with the requested data 308. For example, if the data is customer records; the Data Provider can obtain a Validation Object that verifies the email address contains a single “@” symbol. The Data Provider 304 then packages the data 308 and the one or more Validation Objects 312 into the Data Object 314. The Data Object 314 is returned to the requesting computer implemented process 302.

In the above exemplary Data Provider pseudo code, an executing computer implemented process can supply a single parameter to the store method: a Data Object. The Data Provider can then use the information contained in the Data Object to update the data source and/or validation rules. In some configurations, different parameters can be supplied to the store function.

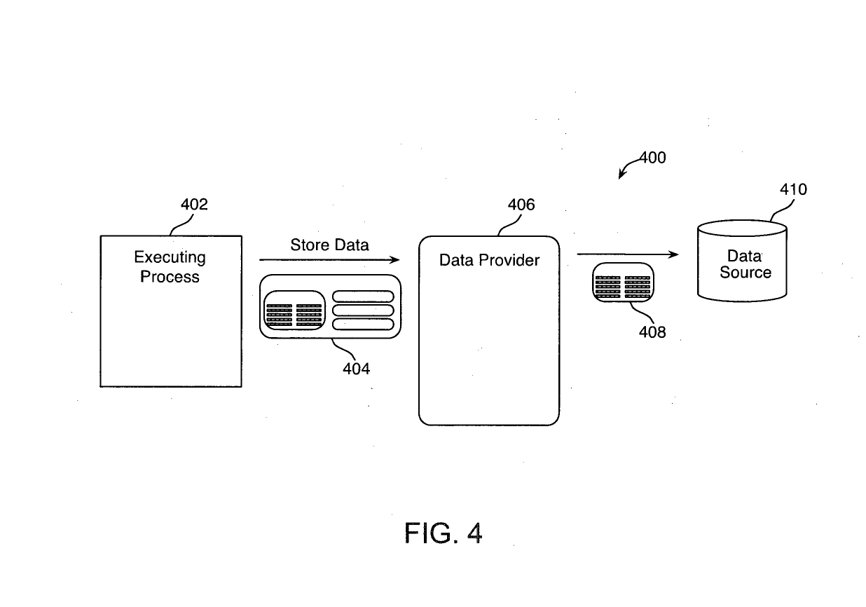

The store Data Object functionality is illustrated in the exemplary method 400 in FIG. 4. The store functionality can be supported such that a computer implemented process can add new data, alter existing data or add new validation rules. For example, if a computer implemented process adds a new field to the data, such as adding a zip code to the customer recording information, it may also be necessary to add a new validation rule.

The executing computer implemented process 402 can make a store request to the Data Provider 406 supplying the Data Object 404. The Data Provider 406 can then extract the data 408 and store it to the data source 410. In some cases, the data source can be a database. Alternatively, the data source 410 can be a file or some other type of data storage. In some configurations, the Data Provider 406 can also update the validation rules based on one or more Validation Objects contained in the Data Object 404.

In addition to the request and store functionality, a Data Provider can also include a description of the validation rules that apply to any data that it can return to a computer implemented process. For example, if a Data Provider can return data sets for either customer records or for customer invoices, the Data Provider can contain validation rules for both data sets. Other implementations of the Data Provider are also possible. For example, the Data Provider can contain additional or different functions and/or information beyond the validation rules.

To validate the data, a validation request can be made to the Data Object. A validation request can be made at any time. For example, an executing computer implemented process may request validation immediately upon receiving the Data Object from the Data Provider. Alternatively, the computer implemented process may request validation after receiving input from the user to ensure that the user entered data is valid prior to adding it to the data set. As another example, a Data Provider may request validation of the data prior to sending the data to the storage location.

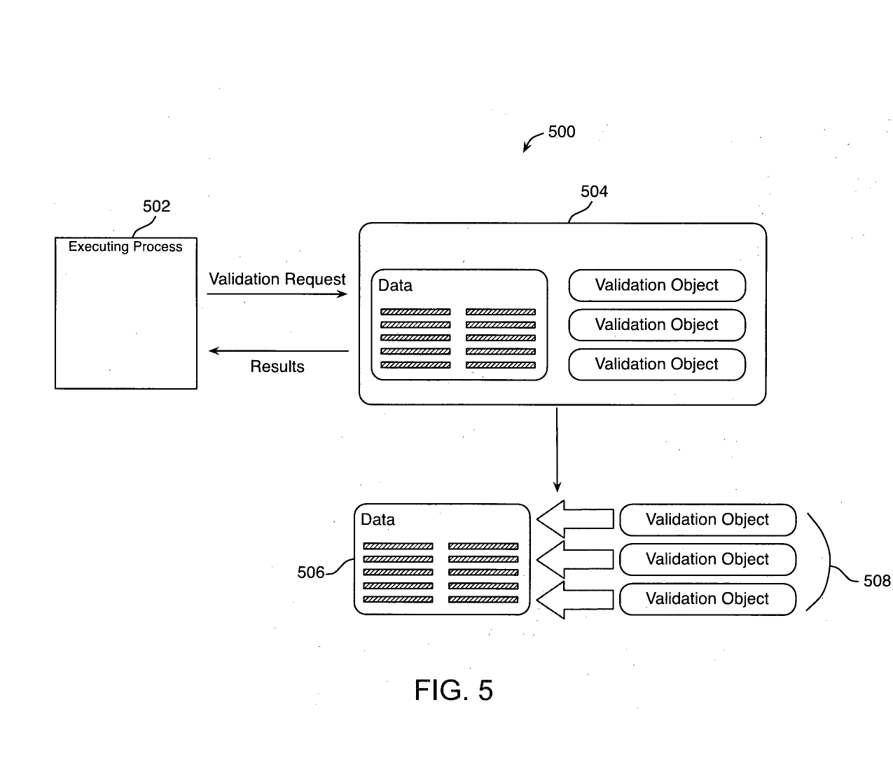

FIG. 5 illustrates an exemplary method 500 for validating the data in a Data Object. In validation method 500, the executing computer implemented process 502 makes a validation request to the Data Object 504. Upon receiving the request, the Data Object 504 instructs each of the Validation Objects 508 to test the validity of the data 506 and then collects the results of the validation checks. The validation results are then returned to the executing computer implemented process 502.

The pseudo code below illustrates an exemplary technique for adding the validation functionality to the Data Object. In this example, a single “validate” function is added to the DataObject class. In this example the “validate” function requires no parameters and returns nothing. This differs slightly from the exemplary validation method 500 in which the validation results were aggregated and returned to the executing computer implemented process. In this configuration, the executing computer implemented process can still be notified of a failed validation through an exception thrown in the Validation Object. Other techniques for implementing the “validate” function are also possible, such as validation functions that support one or more parameters.

public class DataObject {

private List _data = new List( );
private List _validators = new List( );
public addData(Data data){

_data.add(data);

}
public List getData( ) {

return _data;

}
public replaceData(Data oldData, Data newData){

_data.replace(oldData, newData);

}
public void validate( ) {

for (ValidationObject v : _validators) {

v.validate(this);

}

}
public void addValidationObject(ValidationObject validator) {

_validators.add(validator);

}
}

When the data is used in a homogeneous execution environment, the above described validation method is sufficient to address the issue of adding validation methods wherever the data is utilized. However, further functionality is required to prevent the need to add multiple validation methods in a heterogeneous execution environment. To illustrate, in the web server/browser execution environment described above, there would still be a need to add at least one validation check outside of that provided by the Data Object. For example, it may be necessary to add a JavaScript validation check to the browser portion of the execution environment.

To address the heterogeneous nature of many execution environments, a Data Object can include export functionality in which the Data Object can create a representation of itself appropriate for the target computer implemented process. For example, in the web server/browser execution environment the original definition of the Data Object may have been implemented in C++ and compiled to a native binary appropriate for execution on the server. However, a computer implemented process executing on the browser side may require a JavaScript representation of the Data Object. In this case, a computer implemented process can make a request to the Data Object for a JavaScript representation. This JavaScript representation of the Data Object can then be exported to a computer implemented process on the browser side where it can be used to manipulate and verify the data.

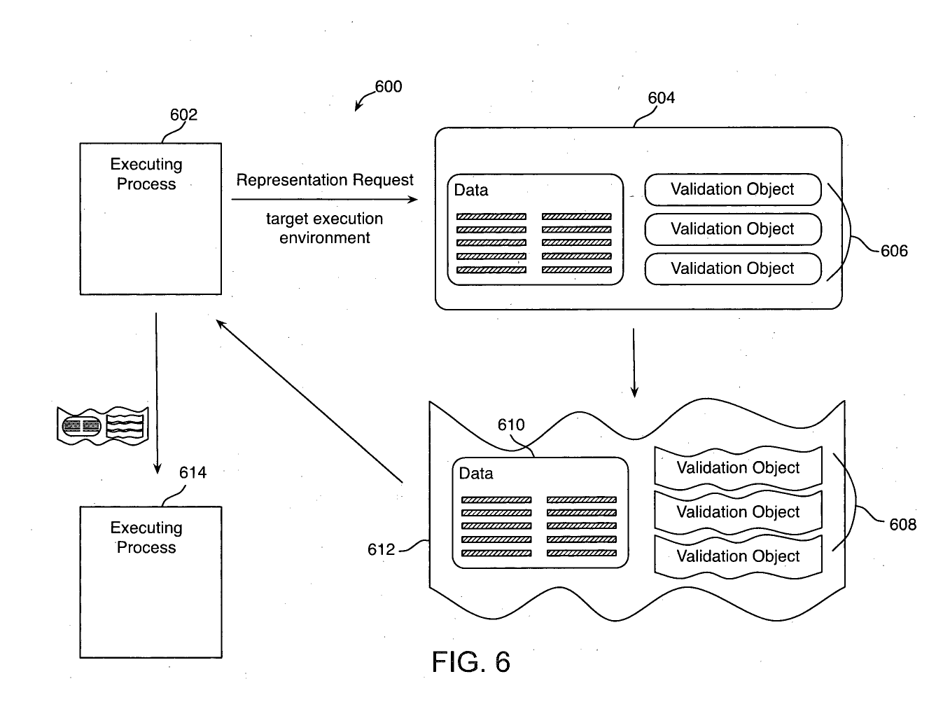

FIG. 6 illustrates an exemplary method 600 for exporting a Data Object. In the export method 600, the executing process 602 makes a request to the Data Object 604 for a representation of itself. In some configurations, the request can include information indicating the target execution environment for the Data Object representation. Once the Data Object 604 receives the request and any necessary target execution environment information, the Data Object 604 can instruct each Validation Object 606 to create an appropriate Validation Object representation of itself 608. The new Validation Objects 608 are then encapsulated with the data 610 to create the Data Object 612 for the target execution environment. The Data Object 612 can be returned to the requesting executing computer implemented process 602. The requesting computer implemented process 602 can then send the target specific Data Object representation to the computer implemented process 614 executing on the target execution environment. Now, when the Data Object 612 reaches the target computer implemented process, the computer implemented process will be able to access the data and verify the validity based on the same validation rules that were defined in the source environment.

The pseudo code below illustrates an exemplary technique for adding the export functionality to the Data Object. In this example, an “ExportableObject” interface can be implemented that includes a single “makeExportableDefinition” function. The “makeExportedDefinition” function takes a single parameter that specifies the target execution environment and returns a String representation of the Data Object. Other techniques for implementing the export functionality are also possible. For example, instead of a single function with a parameter specifying the target execution environment, one or more functions specific to the various target execution environments can be specified. Additionally, other parameters and/or return types are also possible.

public interface ExportableObject {

// Create the definition for the requested platform
String makeExportedDefinition(String targetPlatform);
}

To support the export functionality, a Data Object can implement the

“ExportableObject” interface, as illustrated in the pseudo code below.

public class DataObject implements ExportableObject{

private List _data = new List( );
private List _validators = new List( );
public addData(Data data){

_data.add(data);

}
public List getData( ) {

return _data;

}
public replaceData(Data oldData, Data newData){

_data.replace(oldData, newData);

}
public void validate( ) {

for (ValidationObject v : _validators) {

v.validate(this);

}

}
public void addValidationObject(ValidationObject validator) {

_validators.add(validator);

}
public String makeExportedDefinition(String targetPlatform){

// Only supports JavaScript
if(!targetPlatform.equals(“JavaScript”)){

throw new UnsupportedOperationException( );

}
// Make the string based on the Validation Objects in this Data
Object
String result = ...
return result;

}
}

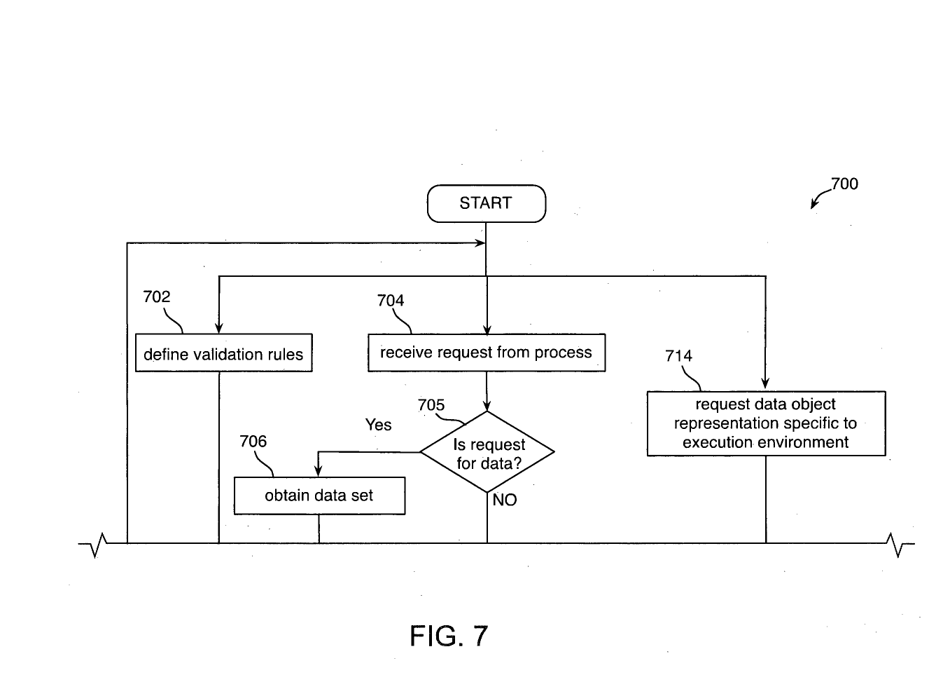

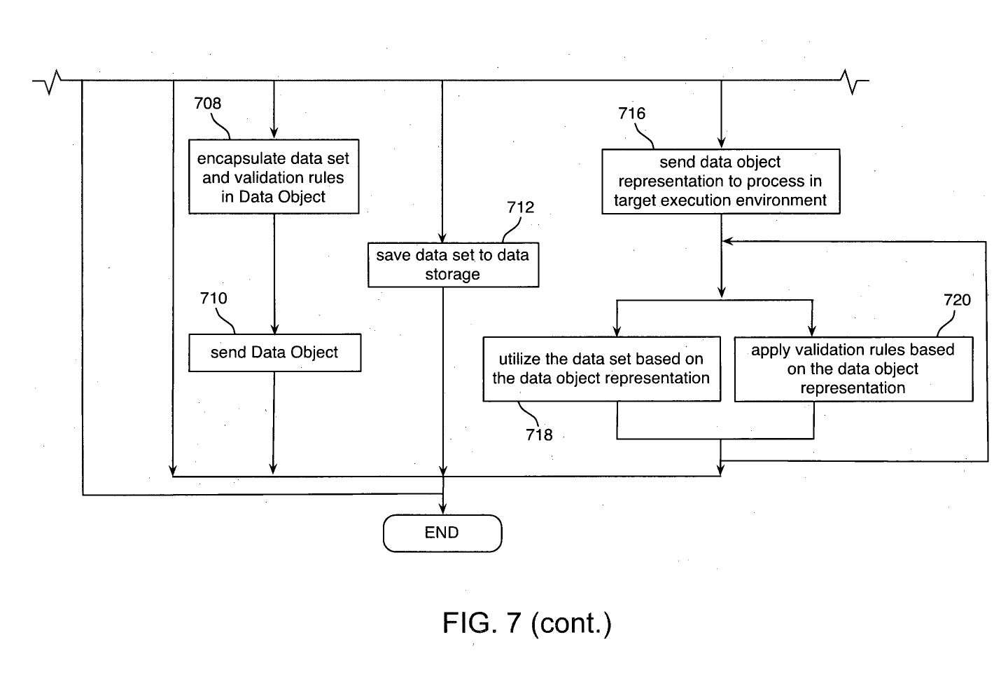

FIG. 7 is a flowchart illustrating an exemplary method 700 for maintaining data integrity across execution environments. For the sake of clarity, this method is discussed in terms of an exemplary execution environment such as is shown in FIG. 1. Although specific steps are shown in FIG. 7, in other embodiments a method can have more or less steps than shown. There are a number of different actions that can occur in the execution environment 100, such as defining validation rules, passing around Data Objects, exporting Data Objects, etc. Depending on the configuration of the execution environment 100, these actions can occur sequentially and/or in parallel. For example, there may be several computer implemented processes executing simultaneously in the execution environment 100. Each of the computer implemented processes can be making requests to Data Providers, utilizing data from a Data Object, validating data, and/or requesting a Data Object specific to a target execution environment. Alternatively, there can be a single process executing in the execution environment 100 that sequentially carries out one or more of the various actions available within the execution environment 100. Regardless of the number of computer implemented processes executing and/or whether or not execution can occur in parallel, method 700 illustrates an exemplary flow of steps that can occur in the execution environment 100.

At one or more points in the execution of the execution environment 100, a user can define validation rules for data utilized within the execution environment 100 (702). The validation rules can be maintained in the Data Provider and can be the basis for one or more Validation Objects. New validation rules can be defined at any point in the execution. Additionally, the validation rules can be altered during the execution.

At various points in the execution of the execution environment 100, a Data Provider can receive a request from an executing computer implemented process (704). Upon receiving the request, the Data Provider determines if it is a request for data or a request to save a Data Object (705). If the Data Provider determines that the request made by the executing computer implemented process is for data, the Data Provider can obtain the data set from the storage location (706). Depending on the configuration of the execution environment 100, the Data Provider may obtain the data from a database, a file, create the data, and/or derive the data from other data. Other data sources are also possible. In some cases, once the Data Provider has obtained the data, it may be necessary for the Data Provider to format the data so that it is usable by the requesting computer implemented process. The Data Provider can then encapsulate the data and one or more Validation Objects in a Data Object (708). After encapsulation, the Data Object is returned to the requesting computer implemented process (710).

Alternatively, if the Data Provider determines that the request made by the executing computer implemented process is to save the Data Object, the Data Provider can save the data set to the storage location (712). Any number of storage locations are possible, such as a database or a file.

After the requesting computer implemented process receives the Data Object, there are number of actions the executing process can take. In some cases, the executing computer implemented process can utilize the data, such as read the data, analyze the data, present the data to a user, etc. The executing process can also make a validation request to the Data Object to verify that the data is in a valid representation. The validation request can occur before or after the executing computer implemented process utilizes the data. In some cases, an executing computer implemented process can make a validation request without utilizing the data. Additionally, a computer implemented process can utilize the data without making a validation request.

The executing process can also make a request to the Data Object to produce a representation of itself for a specific target execution environment (714). The executing process can use the new Data Object representation to pass the data to an executing process in the target execution environment (716). This will allow the receiving computer implemented process to utilize the data (718) and the verification checks (720).

The pseudo code below is an example of how data integrity can be maintained in a heterogeneous execution environment using Data Objects, Validation Objects, and Data Providers. In this example, customer data is being shared in a web server/browser execution environment. Of particular concern in this example, is ensuring the validity of the email field.

```
public class DataRow implements ExportableObject {
  private Map _fields;
  public string getField(String name) { return _fields.get(name); }
  public void setField(String name, String value) { _fields.put(name,
  value); }
  public String makeExportedDefinition(String targetPlatform) {
```

```
// Only supports JavaScript
if (!targetPlatform.equals(“JavaScript”)) {
  throw new UnsupportedOperationException( );
}
// This result in a JavaScript string of the form
// new DataRow({ “fieldname1”: value1, “fieldname2”: value2, ... })
// Where DataRow is a type available on the target platform
StringBuilder result = new StringBuilder( );
result.append(“{”);
boolean first = true;
for (Map.Entry entry : _fields.getEntrySet( )) {
  if (first) { first = false; } else { result.append(“,”) }
  result.append(“\“” + entry.getKey( ) + “\”:\“” +
```

entry.getValue( ) + “\””);

}
result.append(“}”);
return result.toString( );

```
  }
  }
public class DataObject implements ExportableObject {
  private List _allRows = new List( );
  private int _currentRow = −1;
  private List _validators = new List( );
  // Create a row and make it current
  public DataRow createRow( ) {
```

DataRow newRow = new DataRow( );
_allRows.add(newRow);
_currentRow = allRows.getSize( ) − 1;
return newRow;

```
  }
  public getCurrentRow( ) {
```

return _allRows.get(_currentRow);

```
  }
  public List getAllRows( ) {
```

return _allRows;

```
  }
  public void validate( ) {
```

for (ValidationObject v : _validators) {
v.validate(this);
}

```
  }
  public void addValidationObject(ValidationObject validator) {
```

_validators.add(validator);

```
  }
  public String makeExportedDefinition(String targetPlatform) {
```

```
// Only supports JavaScript
if (!targetPlatform.equals(“JavaScript”))
  throw new UnsupportedOperationException( );
// This result in a JavaScript string of the form
// newDataObject([ row1, row2, ... ], [ ValidationObject1,
// ValidationObject2, ...]);
// where DataObject is a JavaScript type available on the target
platform
String result = “new DataObject(” + makeRowArray( ) + “,” +
  makeValidationObjectArray( ) + “)”);
```

```
  }
  public String makeRowArray( ) {
```

```
StringBuilder result = new StringBuilder( );
boolean first = true;
for (DataRow row : _allRows) {
  if (first) { first = false;} else { result.append(“,”) }
  result.append(row.makeJavaScriptDefinition( ));
}
return “[” + result.toString( ) + “]”;
```

```
  }
  public String makeValidationObjectArray( ) {
```

```
StringBuilder result = new StringBuilder( );
boolean first = true;
for (ValidationObject validationObject : _validators) {
  if (first) { first = false; } else { result.append(“,”) }
  result.append(
```

validationObject.makeExportedDefinition(“JavaScript”));

}
return “[” + result.toString( ) + “]”;

```
  }
  }
/**
* Checks that the named field for every row of the DataObject conforms
to the email
* format
*/
public class EmailValidationObject implements ExportableObject {
  private String _fieldName;
  public EmailValidationObject(String fieldName) {
```

_fieldName = fieldName;

```
  }
  public void validate(DataObject dataObject) {
```

```
for (DataRow row : dataObject.getAllRows( )) {
  String fieldValue = row.getField(_fieldName);
  // Simply checks for the presence of the ‘@’ character
  if (fieldValue.contains(“@”)) {
```

return;

} else {

throw new ValidationException(“Invalid email: ” +
fieldValue);

}
}

```
  }
  public String makeExportedDefinition(String targetPlatform) {
```

// Only supports JavaScript
if (!targetPlatform.equals(“JavaScript”)) {
throw new UnsupportedOperationException( );
}
// The resulting definition is of the form
// new EmailValidationObject(“fieldname”);
// where EmailValidationObject is a type available on the target
platform
// that implements email validation
// using an equivalent algorithm to the class described earlier
return “new EmailValidationObject(\“” + _fieldName + “\”)”;

```
  }
  }
/**
* A JDBC DataProvider that supports two operations - retrieving all
customers
* and retrieving a customer by ID
*
* All DataObjects filled through this DataProvider contain a
ValidationObject for
* checking that the email address field is valid
*/
public class JDBCDataProvider implements DataProvider {
  private DataSource _dataSource;
  // Is provided with the datasource against which queries are run
  public JDBCDataProvider(DataSource dataSource) {
```

_dataSource = dataSource;

```
  }
  public DataObject retrieveDataObject(String operationName, Map
  parameters) {
```

```
DataObject result;
if (operationName.equals(“get-all-customers”) {
  result = getAllCustomers( );
} else if (operationName.equals(“get-customer-by-id”) {
  result = getCustomerByID(parameters);
} else {
  throw new Exception(“Unrecognized operation: “‘ +
```

operationName + ’””);

}
// Add email ValidationObject to check field validity
ValidationObject emailValidationObject = new
EmailValidationObject(“email”);
result.addValidationObject(emailValidationObject);

```
  }
  private static String _getAllQuery = “Select * from CUSTOMER”;
  private DataObject getAllCustomers( ) {
```

```
DataObject result = new DataObject( );
// Details of running query ommitted
RecordSet queryResult = _dataSource.runQuery(_getAllQuery);
for (Row row : queryResult) {
  result.createRow( );
  for (Field field : row) {
```

result.getCurrentRow( ).setField(field.getName( ),
field.getValue( ));

}
}
return result;

```
  }
  private static String _getCustomerByID =
```

“Select * from CUSTOMER where ID=?”;

private DataObject getCustomerByID(Map parameters) {

```
PreparedStatement statement =
  _dataSource.prepareStatement(getCustomerByID);
// Expects a Customer ID to be in the parameters Map
String customerID = parameters.get(“CUSTOMER_ID”);
// Substitute into the statement
statement.setParameter(customerID);
DataObject result = new DataObject( );
RecordSet queryResult = _dataSource.runStatement(statement);
for (Row row : queryResult) {
  DataRow newRow = result.createRow( );
  for (Field field : row)
```

newRow.setField(field.getName( ), field.getValue( ));

}
return result;

```
  }
  private static String _updateQuery =
```

“Update CUSTOMERS set name=?, email=? where ID=?”;

public void storeDataObject(DataObject dataObject) {

// for each row, call the update query
for (DataRow row : dataObject.getAllRows( )) {
PreparedStatement statement =

_dataSource.prepareStatement(_updateQuery);

```
  String name = row.getField(“name”);
  String email = row.getField(“email”);
  String id = row.getField(“id”);
  statement.setParameter(name);
  statement.setParameter(email);
  statement.setParameter(i);
  _dataSource.runStatement(statement);
}
```

```
  }
  } // end JDBCDataProvider class
```

The pseudo code below illustrates using a Data Provider to retrieve a Data Object of customer data. Once the executing computer implemented process has the Data Object it can modify the data to add a new email address and then verify that the customer data is in a valid format.

DataProvider customerProvider = retrieveCustomerProvider( );
DataObject customerData = customerProvider.retrieveDataObject(

“get-customer-by-id”, { “CUSTOMER_ID”: 445 });

// Modify the email address
// The new value for the email address may come from, say, a web page
that
// accepts user input
String newEmailAddress = getEnteredEmailAddress( );
customerData.getCurrentRow( ).setField(“email”, newEmailAddress);
// Validate the data object
try {

customerData.validate( );

} catch (ValidationException v) {

throw new RuntimeException(“The email address is not valid”);

}
// Store the data object to persist the data
customerProvider.storeDataObject(customerData);
}

Finally, using the pseudo code below, the Data Object can create a JavaScript representation of itself for use on the browser side of the system 100.

DataProvider customerProvider = retrieveCustomerProvider( );
DataObject customerData = customerProvider.retrieveDataObject(

“get-customer-by-id”, { “CUSTOMER_ID”: 445 });

// Create the exported definition for the JavaScript platform
String dataDefinition =
customerData.makeExportedDefinition(“JavaScript”);
// Show an HTML Page that displays the data to the user
// Include the definition of the customerData DataObject so that the data
can be
// read, and that includes the definition of the ValidationObject so that the
rules
// can be applied in that environment as well.
showEditCustomerScreen(dataDefinition);

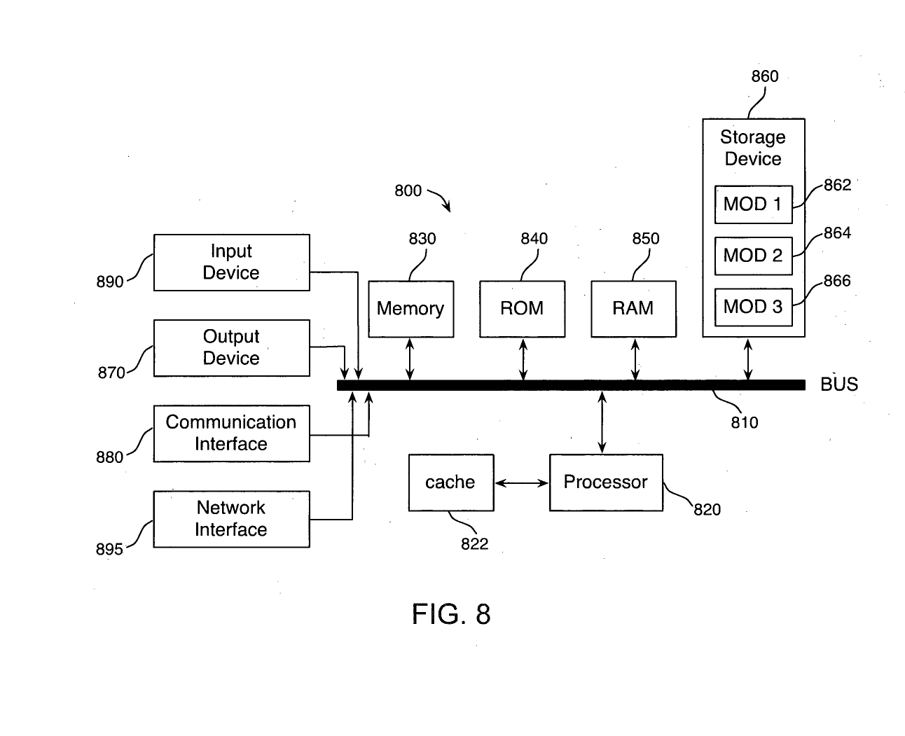

With reference to FIG. 8, an exemplary system 800 includes a general-purpose computing device 800, including a processing unit (CPU or processor) 820 and a system bus 810 that couples various system components including the system memory 830 such as read only memory (ROM) 840 and random access memory (RAM) 850 to the processor 820. The system 800 can include a cache of high speed memory connected directly with, in close proximity to, or integrated as part of the processor 820. The system 800 copies data from the memory 830 and/or the storage device 860 to the cache for quick access by the processor 820. In this way, the cache provides a performance boost that avoids processor 820 delays while waiting for data. These and other modules can be configured to control the processor 820 to perform various actions. Other system memory 830 may be available for use as well. The memory 830 can include multiple different types of memory with different performance characteristics. It can be appreciated that the disclosure may operate on a computing device 800 with more than one processor 820 or on a group or cluster of computing devices networked together to provide greater processing capability. The processor 820 can include any general purpose processor and a hardware module or software module, such as module 1 862, module 2 864, and module 3 866 stored in storage device 860, configured to control the processor 820 as well as a special-purpose processor where software instructions are incorporated into the actual processor design. The processor 820 may essentially be a completely self-contained computing system, containing multiple cores or processors, a bus, memory controller, cache, etc. A multi-core processor may be symmetric or asymmetric.

The system bus 810 may be any of several types of bus structures including a memory bus or memory controller, a peripheral bus, and a local bus using any of a variety of bus architectures. A basic input/output (BIOS) stored in ROM 840 or the like, may provide the basic routine that helps to transfer information between elements within the computing device 800, such as during start-up. The computing device 800 further includes storage devices 860 such as a hard disk drive, a magnetic disk drive, an optical disk drive, tape drive or the like. The storage device 860 can include software modules 862, 864, 866 for controlling the processor 820. Other hardware or software modules are contemplated. The storage device 860 is connected to the system bus 810 by a drive interface. The drives and the associated computer readable storage media provide nonvolatile storage of computer readable instructions, data structures, program modules and other data for the computing device 800. In one aspect, a hardware module that performs a particular function includes the software component stored in a non-transitory computer-readable medium in connection with the necessary hardware components, such as the processor 820, bus 810, display 870, and so forth, to carry out the function. The basic components are known to those of skill in the art and appropriate variations are contemplated depending on the type of device, such as whether the device 800 is a small, handheld computing device, a desktop computer, or a computer server.

Although the exemplary embodiment described herein employs the hard disk 860, it should be appreciated by those skilled in the art that other types of computer readable media which can store data that are accessible by a computer, such as magnetic cassettes, flash memory cards, digital versatile disks, cartridges, random access memories (RAMs) 850, read only memory (ROM) 840, a cable or wireless signal containing a bit stream and the like, may also be used in the exemplary operating environment. Non-transitory computer-readable storage media expressly exclude media such as energy, carrier signals, electromagnetic waves, and signals per se.

To enable user interaction with the computing device 800, an input device 890 represents any number of input mechanisms, such as a microphone for speech, a touch-sensitive screen for gesture or graphical input, keyboard, mouse, motion input, speech and so forth. An output device 870 can also be one or more of a number of output mechanisms known to those of skill in the art. In some instances, multimodal systems enable a user to provide multiple types of input to communicate with the computing device 800. The communications interface 880 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 820. The functions these blocks represent may be provided through the use of either shared or dedicated hardware, including, but not limited to, hardware capable of executing software and hardware, such as a processor 820, that is purpose-built to operate as an equivalent to software executing on a general purpose processor. For example the functions of one or more processors presented in FIG. 8 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 840 for storing software performing the operations discussed below, and random access memory (RAM) 850 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 800 shown in FIG. 8 can practice all or part of the recited methods, can be a part of the recited systems, and/or can operate according to instructions in the recited non-transitory computer-readable storage media. Such logical operations can be implemented as modules configured to control the processor 820 to perform particular functions according to the programming of the module. For example, FIG. 8 illustrates three modules Mod1 862, Mod2 864 and Mod3 866 which are modules configured to control the processor 820. These modules may be stored on the storage device 860 and loaded into RAM 850 or memory 830 at runtime or may be stored as would be known in the art in other computer-readable memory locations.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is, transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. Those skilled in the art will readily recognize various modifications and changes that may be made to the principles described herein without following the example embodiments and applications illustrated and described herein, and without departing from the spirit and scope of the disclosure.

1. A computer implemented method comprising:
associating at least one validation object with a data set;
receiving a request for the data set from at least one executing process;
encapsulating the data set and the at least one validation object in a data object; and
sending the data object to the at least one executing process.

2. The computer implemented method as recited in claim 1, further comprising associating the at least one validation object with the data set and at least one validation rule governing the use of the data set.

3. The computer implemented method as recited in claim 1, wherein the data object is capable of providing a representation of the data object to the at least one executing process.

4. The computer implemented method as recited in claim 1, wherein the validation object comprises a validation function for executing the at least one validation rule.

5. The computer implemented method as recited in claim 1, further comprising:
generating a representation of the data object;
wherein receiving comprises receiving a request for the data set from at least two executing processes; and
wherein sending comprises sending the representation of the data object to the at least two executing processes.

6. The computer implemented method as recited in claim 5, wherein the representation of the data object is provided to the at least two executing processes in at least two programming languages.

7. The computer implemented method as recited in claim 1, further comprising:
receiving a request to store the data object; and
storing the data object.

8. A computer implemented method comprising:
sending from at least one executing process, a request for a data set;
receiving at the at least one executing process, a representation of a data object comprising the data set and at least one validation object, wherein the validation object comprises a validation function for executing at least one validation rule governing the use of the data set; and
applying the at least one validation rule to execute the at least one executing process.

9. A computer-readable medium comprising computer-readable code stored on the computer-readable medium for causing a computer to perform the computer implemented method as recited in claim 1.

10. A device comprising a processor configured to perform the computer implemented method as recited in claim 1.

11. The computer implemented method as recited in claim 2, wherein the data object is capable of providing a representation of the data object to the at least one executing process.

12. The computer implemented method as recited in claim 2, wherein the validation object comprises a validation function for executing the at least one validation rule.

13. The computer implemented method as recited in claim 3, wherein the validation object comprises a validation function for executing the at least one validation rule.

14. The computer implemented method as recited in claim 2, further comprising:
receiving a request to store the data object; and storing the data object.

15. The computer implemented method as recited in claim 3, further comprising:
receiving a request to store the data object; and storing the data object.

16. The computer implemented method as recited in claim 4, further comprising:
receiving a request to store the data object; and storing the data object.

17. The computer implemented method as recited in claim 5, further comprising:
receiving a request to store the data object; and storing the data object.

18. The computer implemented method as recited in claim 6, further comprising:
receiving a request to store the data object; and storing the data object.

19. A computer-readable medium comprising computer-readable code stored on the computer-readable medium for causing a computer to perform the computer implemented method as recited in claim 8.

20. A device comprising a processor configured to perform the computer implemented method as recited in claim 8.
